(19) United States
(12) Patent Application Publication
(10) Pub. No.: US 2004/0149496 A1
(43) Pub. Date: Aug. 5, 2004

(54) Digital type pointer indicator

(76) Inventors: Pin-Hsin Ho, Taichung (TW); Yu-Mei Chen, Taichung (TW)

Correspondence Address: CHARLES E. BAXLEY, ESQUIRE, Fifth Floor, 59 John Street, New York, NY, 10038, US

(21) Appl. No.: 10/357,770

(22) Filed: Feb. 4, 2003

(51) Int. Cl. G01G 23/14

(52) U.S. Cl. 177/173

(57) ABSTRACT

A digital type pointer indicator includes a signal output unit, a microprocessor unit, a digital display unit, and a pointer unit. The pointer unit includes a digital/analogue conversion control unit, a step motor, and a pointer. Thus, the digital type pointer indicator provides a digital indication manner and a pointer indication manner simultaneously, so that the user has two value reading manners, thereby facilitating the user identifying the value of the weight of the object to be measured.

### BACKGROUND OF THE INVENTION

1. Field of the Invention

The present invention relates to a digital type pointer indicator, and more particularly to a digital type pointer indicator that provides a digital indication manner and a pointer indication manner simultaneously, so that the user has two value reading manners, thereby facilitating the user identifying the value of the weight of the object to be measured.

2. Description of the Related Art

A conventional weight measuring device in accordance with the prior art comprises a mechanical scale and an electronic scale.

The mechanical scale has an inside provided with a spring. Thus, when the object to be measured is placed on the mechanical scale, the spring elastically drives the pointer to point to the reading value on the scale panel, thereby indicating the weight of the object to be measured. However, the mechanical scale cannot exactly measure the weight of the object to be measured.

The electronic scale can directly and exactly measure the weight of the object to be measured. However, the display panel of the electronic scale often indicates various values simultaneously, such as the height, the weight, the time, etc., so that the user cannot directly identify the value representing the weight of the object to be measured, thereby causing inconvenience to the user.

### SUMMARY OF THE INVENTION

The present invention is to mitigate and/or obviate the disadvantage of the conventional weight measuring device.

The primary objective of the present invention is to provide a digital type pointer indicator that provides a digital indication manner and a pointer indication manner simultaneously, so that the user has two value reading manners, thereby facilitating the user identifying the value of the weight of the object to be measured.

Another objective of the present invention is to provide a digital type pointer indicator indicates the weight of the object to be measured by the digital display unit and by the pointer of the pointer unit, so that the user can doubly read the weight of the object to be measured through the digital display unit and through the pointer of the pointer unit, thereby facilitating the user identifying the value of the weight of the object, and thereby preventing the user from misunderstanding the value of the weight of the object.

A further objective of the present invention is to provide a digital type pointer indicator, wherein the digital impulse signal output from the digital/analogue conversion control unit of the pointer unit is very exact, so that the rotation shaft of the step motor is operated and rotated exactly and precisely, thereby enhancing the precision of the pointer of the pointer unit 4 on the scale of the scale panel, so as to point the weight of the object exactly.

In accordance with the present invention, there is provided a digital type pointer indicator, comprising a signal output unit, a microprocessor unit, a digital display unit, and a pointer unit, wherein:

the signal output unit outputs an electronic signal according to a weight of an object to be measured;

the microprocessor unit is connected to the signal output unit, the microprocessor unit converts the electronic signal output from the signal output unit into a digital signal, and outputs the digital signal;

the digital display unit is connected to the microprocessor unit, the digital display unit converts the digital signal output from the microprocessor unit into a value, and indicates the value; and

the pointer unit is connected to the microprocessor unit, the pointer unit includes a digital/analogue conversion control unit, a step motor, and a pointer, wherein:

the digital/analogue conversion control unit of the pointer unit converts the digital signal output from the microprocessor unit into a digital impulse signal and outputs the digital impulse signal;

the step motor of the pointer unit is connected to the digital/analogue conversion control unit, and is driven by the digital impulse signal output from the digital/analogue conversion control unit to rotate through a fixed angle; and

the pointer of the pointer unit is driven to move by the step motor.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a digital type pointer indicator in accordance with the preferred of the present invention;

FIG. 2 is a schematic structural view of the digital type pointer indicator in accordance with the preferred of the present invention; and

FIG. 3 is a schematic plan operational view of the digital type pointer indicator in accordance with the preferred of the present invention.

### DETAILED DESCRIPTION OF THE INVENTION

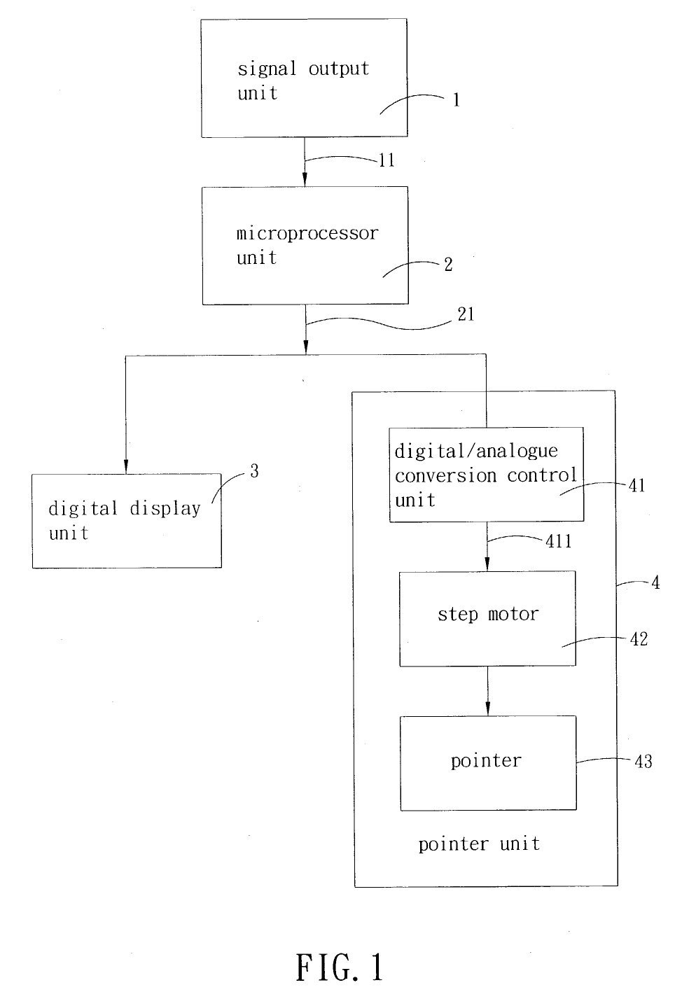

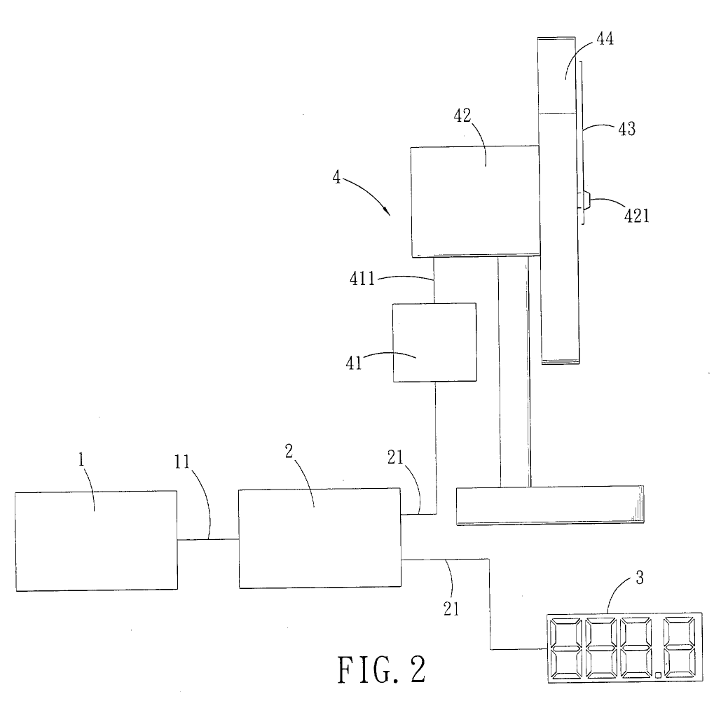

Referring to the drawings and initially to FIGS. 1 and 2, a digital type pointer indicator in accordance with the preferred embodiment of the present invention comprises a signal output unit 1, a microprocessor unit 2, a digital display unit 3, and a pointer unit 4.

The signal output unit 1 is an externally connected signal output unit. The signal output unit 1 has an inside provided with a bearing load member (not shown) that is required for measuring the weight of the object to be measured. Thus, when the object to be measured is placed on the signal output unit 1, the signal output unit 1 outputs an electronic signal 11 by detection of the bearing load member. The electronic signal 11 is varied according to the weights of the different objects to be measured.

The microprocessor unit 2 is connected to the signal output unit 1. The microprocessor unit 2 converts the electronic signal 11 output from the signal output unit 1 into a digital signal 21, and outputs the digital signal 21.

The digital display unit 3 is connected to the microprocessor unit 2. The digital display unit 3 converts the digital signal 21 output from the microprocessor unit 2 into a value, and indicates the value.

The pointer unit 4 is connected to the microprocessor unit 2. The pointer unit 4 includes a digital/analogue conversion control unit 41, a step motor 42, and a pointer 43.

The digital/analogue conversion control unit 41 of the pointer unit 4 is connected to the microprocessor unit 2. The digital/analogue conversion control unit 41 of the pointer unit 4 converts the digital signal 21 output from the microprocessor unit 2 into a digital impulse signal 411 and outputs the digital impulse signal 411.

The step motor 42 of the pointer unit 4 is connected to the digital/analogue conversion control unit 41, and is mounted on a scale panel 44. The step motor 42 of the pointer unit 4 has a rotation shaft 421 protruding outward from a center of the scale panel 44. Preferably, the scale panel 44 has a circular shape. In operation, the step motor 42 of the pointer unit 4 receives the digital impulse signal 411 output from the digital/analogue conversion control unit 41. Thus, the step motor 42 of the pointer unit 4 is driven by the digital impulse signal 411 output from the digital/analogue conversion control unit 41, so that the rotation shaft 421 of the step motor 42 is rotated through a fixed angle.

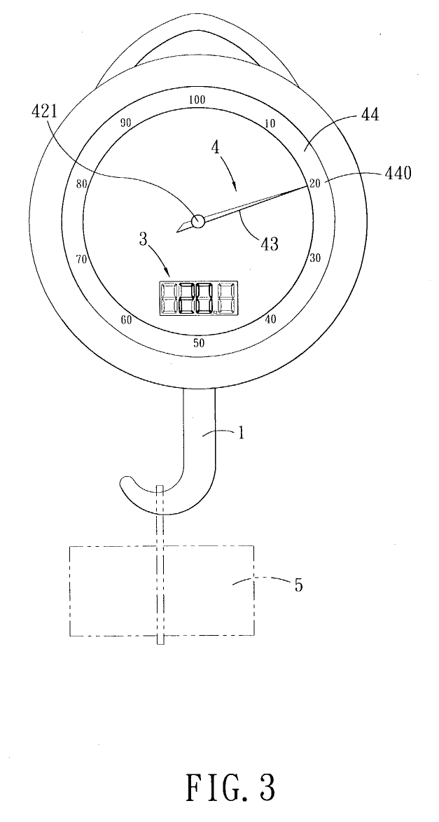

The pointer 43 of the pointer unit 4 has a first end secured on the rotation shaft 421 of the step motor 42 to rotate therewith and a second end directed toward the scale 440 (see FIG. 3) on the scale panel 44. In addition, the pointer 43 of the pointer unit 4 is moved according to the fixed angle of the rotation shaft 421 of the step motor 42.

In practice, when the object to be measured is placed on the signal output unit 1, the signal output unit 1 outputs an electronic signal 11 by detection of the bearing load member. Then, the microprocessor unit 2 converts the electronic signal 11 output from the signal output unit 1 into a digital signal 21, and outputs the digital signal 21. Then, the digital signal 21 output from the microprocessor unit 2 is transmitted to the digital display unit 3 and the pointer unit 4 respectively. At this time, the digital display unit 3 converts the digital signal 21 output from the microprocessor unit 2 into a value, and indicates the value transferred from the digital signal 21, wherein the indicated value is the weight of the object to be measured. At the same time, the pointer 43 of the pointer unit 4 is pointed to the value of the scale 440 (see FIG. 3) on the scale panel 44, wherein the value is the weight of the object to be measured. In addition, the value of the scale 440 (see FIG. 3) on the scale panel 44 pointed by the pointer 43 of the pointer unit 4 is exactly the value indicated on the digital display unit 3.

Thus, the digital type pointer indicator in accordance with the present invention can indicate the weight of the object to be measured by the digital display unit 3 and by the pointer 43 of the pointer unit 4.

For example, as shown in FIG. 3, after the object 5 to be measured is placed on the signal output unit 1, the signal output unit 1 outputs an electronic signal 11 that is processed by the microprocessor unit 2 which converts the electronic signal 11 into a digital signal 21, and outputs the digital signal 21 to the digital display unit 3 and the pointer unit 4 respectively. Thus, the value representing the weight of the object 5 is indicated on the digital display unit 3, and is pointed by the pointer 43 of the pointer unit 4 on the scale 440 of the scale panel 44.

Accordingly, the user can doubly read the weight of the object 5 to be measured through the digital display unit 3 and through the pointer 43 of the pointer unit 4, thereby facilitating the user identifying the value of the weight of the object 5, and thereby preventing the user from misunderstanding the value of the weight of the object 5.

In addition, in the digital type pointer indicator in accordance with the present invention, the digital/analogue conversion control unit 41 of the pointer unit 4 converts the digital signal 21 output from the microprocessor unit 2 into a digital impulse signal 411 and outputs the digital impulse signal 411. The magnitude of the digital signal 21 is determined according to the weight of the object 5. Thus, the digital impulse signal 411 output from the digital/analogue conversion control unit 41 of the pointer unit 4 is very exact, so that the rotation shaft 421 of the step motor 42 is operated and rotated exactly and precisely, thereby enhancing the precision of the pointer 43 of the pointer unit 4 on the scale 440 of the scale panel 44, so as to point the weight of the object 5 exactly.

While the preferred embodiment(s) of the present invention has been shown and described, it will be apparent to those skilled in the art that various modifications may be made in the embodiment(s) without departing from the spirit of the present invention. Such modifications are all within the scope of the present invention.

What is claimed is:

1. A digital type pointer indicator, comprising a signal output unit, a microprocessor unit, a digital display unit, and a pointer unit, wherein:
the signal output unit outputs an electronic signal according to a weight of an object to be measured;
the microprocessor unit is connected to the signal output unit, the microprocessor unit converts the electronic signal output from the signal output unit into a digital signal, and outputs the digital signal;
the digital display unit is connected to the microprocessor unit, the digital display unit converts the digital signal output from the microprocessor unit into a value, and indicates the value; and
the pointer unit is connected to the microprocessor unit, the pointer unit includes a digital/analogue conversion control unit, a step motor, and a pointer, wherein:
the digital/analogue conversion control unit of the pointer unit converts the digital signal output from the microprocessor unit into a digital impulse signal and outputs the digital impulse signal;
the step motor of the pointer unit is connected to the digital/analogue conversion control unit, and is driven by the digital impulse signal output from the digital/analogue conversion control unit to rotate through a fixed angle; and
the pointer of the pointer unit is driven to move by the step motor.

2. The digital type pointer indicator in accordance with claim 1, wherein the digital/analogue conversion control unit of the pointer unit is connected to the microprocessor unit.

3. The digital type pointer indicator in accordance with claim 1, wherein the step motor of the pointer unit is mounted on a scale panel.

4. The digital type pointer indicator in accordance with claim 3, wherein the scale panel has a circular shape.

5. The digital type pointer indicator in accordance with claim 3, wherein the step motor of the pointer unit has a rotation shaft protruding outward from a center of the scale panel.

6. The digital type pointer indicator in accordance with claim 5, wherein the step motor of the pointer unit is driven by the digital impulse signal output from the digital/analogue conversion control unit, so that the rotation shaft of the step motor is rotated through a fixed angle.

7. The digital type pointer indicator in accordance with claim 5, wherein the pointer of the pointer unit has a first end secured on the rotation shaft of the step motor to rotate therewith and a second end directed toward a scale on the scale panel.

8. The digital type pointer indicator in accordance with claim 6, wherein the pointer of the pointer unit is moved according to the fixed angle of the rotation shaft of the step motor.
